(19) United States
(12) Patent Application Publication
(10) Pub. No.: US 2022/0297723 A1
(43) Pub. Date: Sep. 22, 2022

(54) MOVING ROUTE CALCULATION APPARATUS, VEHICLE CONTROL SYSTEM, MOVING ROUTE CALCULATION METHOD, AND MOVING ROUTE CALCULATION PROGRAM

(71) Applicant: TOYOTA JIDOSHA KABUSHIKI KAISHA, Toyota-shi (JP)

(72) Inventors: Takumi SHIGEMASA, Toyota-shi (JP); Daisuke ASAMI, Toyota-shi (JP); Tomoaki IHARA, Toyota-shi (JP)

(73) Assignee: TOYOTA JIDOSHA KABUSHIKI KAISHA, Toyota-shi (JP)

(21) Appl. No.: 17/586,963

(22) Filed: Jan. 28, 2022

(30) Foreign Application Priority Data
Mar. 16, 2021 (JP) 2021-042235

(51) Int. Cl. B60W 60/00; G06V 20/58

(52) U.S. Cl. CPC B60W 60/0011; G06V 20/58; B60W 2554/4041; B60W 2420/42

(57) ABSTRACT

A moving route calculation apparatus configured to calculate a moving route for an autonomous vehicle, includes a first route calculation unit configured to calculate a first route, the first route being a moving route from a start position to one of a plurality of wide-area target points located in a surrounding area of a target position, a database in which a plurality of moving routes are stored, and a second route setting unit configured to set, among the plurality of moving routes stored in the database, a moving route from a wide-area target point corresponding to the arrival point of the autonomous vehicle, which has moved along the first route, to the target position as a second route, the second route being a moving route from the arrival point of the autonomous vehicle to the target position.

### CROSS REFERENCE TO RELATED APPLICATIONS

This application is based upon and claims the benefit of priority from Japanese patent application No. 2021-42235, filed on Mar. 16, 2021, the disclosure of which is incorporated herein in its entirety by reference.

### BACKGROUND

The present disclosure relates to a moving route calculation apparatus, a vehicle control system, a moving route calculation method, and a moving route calculation program.

In recent years, development of an autonomously moving type vehicle (hereinafter referred to as “an autonomous vehicle”) that automatically moves a vehicle body of the vehicle itself to a target position where the vehicle has a predetermined positional relation with a target object such as an object to be conveyed has been underway.

A vehicle disclosed in Japanese Unexamined Patent Application Publication No. 2017-182502 includes: a wide-area route data generation unit that generates a wide-area route data for moving a vehicle body from a first specified position to a second specified position; an approaching route data generation unit that generates an approaching route data for moving the vehicle body from the second specified position to a target position for a target object; and a route data switching unit that, when the approaching route data is generated, switches a traveling route along which the vehicle body travels from the wide-area route data to the approaching route data. Note that the approaching route data generation unit generates the approaching route data while the vehicle body is traveling according to the generated wide-area route data. In this way, the vehicle can switch the traveling route along which its vehicle body travels from the wide-area route data to the approaching route data without stopping the vehicle body itself, thereby making it possible to reduce the time required to move the vehicle body to the target position.

### SUMMARY

In the vehicle disclosed in Japanese Unexamined Patent Application Publication No. 2017-182502, when the generation of an approaching route data takes time, the generation of the approaching route data may not be completed while the vehicle body is traveling according to the wide-area route data. In such a case, after having the vehicle body travel according to the wide-area route data, the vehicle needs to stop its vehicle body and wait until the approaching route data is generated. Therefore, in the related art, there is a problem that the vehicle body cannot be speedily moved to the target position.

The present disclosure has been made in view of the above-described background, and an object thereof is to provide a moving route calculation apparatus, a vehicle control system, a moving route calculation method, and a moving route calculation program capable of promptly determining a moving route and speedily moving an autonomous moving body to a target position.

A first exemplary aspect is a moving route calculation apparatus configured to calculate a moving route for an autonomous vehicle, including: a first route calculation unit configured to calculate a first route, the first route being a moving route from a start position to one of a plurality of wide-area target points located in a surrounding area of a target position; a database in which a plurality of moving routes each of which is a moving route from a respective one of the plurality of wide-area target points to the target position are stored; and a second route setting unit configured to set, among the plurality of moving routes stored in the database, a moving route from a wide-area target point corresponding to the arrival point of the autonomous vehicle, which has moved along the first route, to the target position as a second route, the second route being a moving route from the arrival point of the autonomous vehicle to the target position. When the autonomous vehicle arrives at a surrounding area in which the autonomous vehicle can recognize the target position, the above-described moving route calculation apparatus can extract a moving route from the arrival point to the target position from the database in which a plurality of moving routes are stored in advance, and promptly set the extracted moving route. Therefore, the above-described moving route calculation apparatus can speedily move the autonomous vehicle to the target position without having the autonomous vehicle wait for the setting of the moving route.

The moving route calculation apparatus may further include a relative position calculation unit configured to calculate a relative position of the target position relative to the arrival point of the autonomous vehicle, which has moved along the first route; in the database, a plurality of relative positions of the target position each of which is a relative position relative to a respective one of the plurality of wide-area target points and a plurality of moving routes each of which is a moving route from a respective one of the plurality of wide-area target points to the target position may be stored while the plurality of relative positions of the target position and the plurality of moving routes may be associated with each other; and the second route setting unit may set, among the plurality of moving routes stored in the database, a moving route corresponding to the relative position calculated by the relative position calculation unit as the second route, which is the moving route from the arrival point of the autonomous vehicle to the target position.

The surrounding area of the target position may be an area in which the target position can be specified by the relative position calculation unit.

The relative position calculation unit may calculate the relative position of the target position from the arrival point of the autonomous vehicle based on an image of the target position taken by a camera.

The relative position calculation unit may calculate the relative position of the target position from the arrival point of the autonomous vehicle based on a sensing result of the target position obtained by a position detection sensor.

The second route setting unit may set, among the plurality of moving routes stored in the database, a moving route from a wide-area target point that is coincident with or within a predetermined error range from the arrival point of the autonomous vehicle to the target position as the second route, which is the moving route from the arrival point of the autonomous vehicle to the target position.

The second route setting unit may set, among the plurality of moving routes stored in the database, a moving route from a wide-area target point closest to the arrival point of the autonomous vehicle to the target position as the second route, which is the moving route from the arrival point of the autonomous vehicle to the target position.

Another exemplary aspect is a vehicle control system including: one of the above-described moving route calculation apparatuses; and a control apparatus configured to move an autonomous vehicle along a moving route calculated by the moving route calculation apparatus.

Another exemplary aspect is a vehicle control system including: one of the above-described moving route calculation apparatuses; the camera; and a control apparatus configured to move an autonomous vehicle along a moving route calculated by the moving route calculation apparatus.

Another exemplary aspect is a vehicle control system including: one of the above-described moving route calculation apparatuses; the position detection sensor; and a control apparatus configured to move an autonomous vehicle along a moving route calculated by the moving route calculation apparatus.

Another exemplary aspect is a method for calculating a moving route, including: calculating a first route, the first route being a moving route from a start position to one of a plurality of wide-area target points located in a surrounding area of a target position; and setting, among a plurality of moving routes each of which is a moving route from a respective one of the plurality of wide-area target points to the target position, stored in a database, a moving route from a wide-area target point corresponding to an arrival point of the autonomous vehicle, which has moved along the first route, to the target position as a second route, the second route being a moving route from the arrival point of the autonomous vehicle to the target position. According to the above-described method for calculating a moving route, when the autonomous vehicle arrives at a surrounding area in which the autonomous vehicle can recognize the target position, it is possible to extract a moving route from the arrival point to the target position from the database in which a plurality of moving routes are stored in advance, and promptly set the extracted moving route. Therefore, the above-described method for calculating a moving route can make it possible to speedily move the autonomous vehicle to the target position without having the autonomous vehicle wait for the setting of the moving route.

Another exemplary aspect is a moving route calculation program for causing a computer to perform: a process of calculating a first route, the first route being a moving route from a start position to one of a plurality of wide-area target points located in a surrounding area of a target position; and a process of setting, among a plurality of moving routes each of which is a moving route from a respective one of the plurality of wide-area target points to the target position, stored in a database, a moving route from a wide-area target point corresponding to an arrival point of the autonomous vehicle, which has moved along the first route, to the target position as a second route, the second route being a moving route from the arrival point of the autonomous vehicle to the target position. According to the above-described moving route calculation program, when the autonomous vehicle arrives at a surrounding area in which the autonomous vehicle can recognize the target position, it is possible to extract a moving route from the arrival point to the target position from the database in which a plurality of moving routes are stored in advance, and promptly set the extracted moving route. Therefore, the above-described moving route calculation program can make it possible to speedily move the autonomous vehicle to the target position without having the autonomous vehicle wait for the setting of the moving route.

According to the present disclosure, it is possible to provide a moving route calculation apparatus, a vehicle control system, a moving route calculation method, and a moving route calculation program capable of promptly determining a moving route and speedily moving an autonomous moving body to a target position.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing an example of a configuration of a vehicle control system according to a first embodiment;

FIG. 2 is a schematic diagram of an autonomous vehicle to which the vehicle control system shown in FIG. 1 is applied;

FIG. 3 is a diagram for explaining an outline of calculation of a moving route R1 performed by the vehicle control system shown in FIG. 1;

FIG. 4 is a diagram for explaining an outline of a setting of a moving route R2 performed by the vehicle control system shown in FIG. 1;

FIG. 5 shows a list of reference numbers of a plurality of relative positions stored in a database;

FIG. 6 shows an example of a plurality of trajectory data (moving routes) corresponding to the reference numbers of the plurality of relative positions stored in the database; and

FIG. 7 is a flowchart showing operations performed by the vehicle control system shown in FIG. 1.

### DESCRIPTION OF EMBODIMENTS

The present disclosure will be explained hereinafter through embodiments according to the present disclosure. However, the below-shown embodiments are not intended to limit the scope of the present disclosure specified in the claims. Further, all the components/structures described in the embodiments are not necessarily indispensable as means for solving the problem. For clarifying the explanation, the following description and the drawings are partially omitted and simplified as appropriate. The same reference numerals (or symbols) are assigned to the same elements throughout the drawings and redundant explanations thereof are omitted as appropriate.

<First Embodiment>

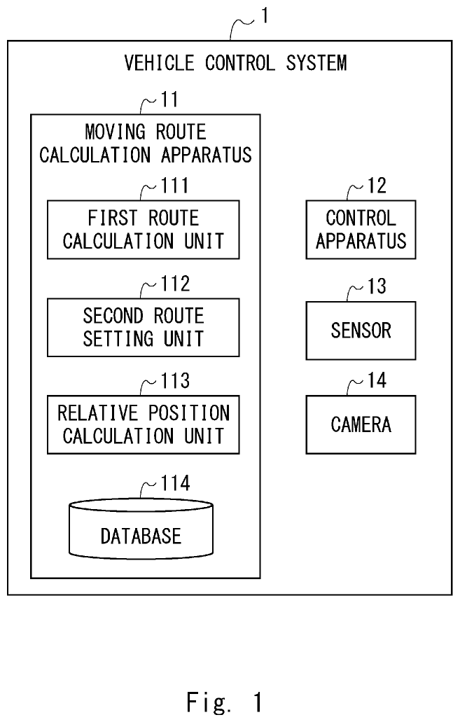

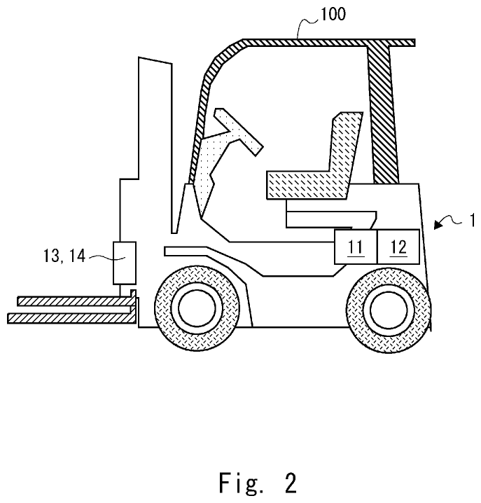

FIG. 1 is a block diagram showing an example of a configuration of a vehicle control system 1 according to a first embodiment. As shown in FIG. 2, the vehicle control system 1 is, for example, a system that is installed in an autonomous vehicle 100 such as an unmanned forklift truck, and is configured to move the autonomous vehicle 100 to a target position TP where it has a predetermined positional relation with a target object such as an object to be conveyed. Note that the vehicle control system 1 according to this embodiment extracts, when the autonomous vehicle 100 arrives at an area where it can recognize the target position TP, a moving route from this arrival point to the target position TP from a database in which a plurality of moving routes are stored in advance, and promptly sets the extracted moving route. In this way, the vehicle control system 1 according to this embodiment does not need to have the autonomous vehicle 100 wait for the setting of the moving route, so that it can speedily move the autonomous vehicle 100 to the target position TP. A detailed description thereof will be given hereinafter.

As shown in FIG. 1, the vehicle control system 1 includes a moving route calculation apparatus 11, a control apparatus 12, a sensor 13, and a camera 14.

The moving route calculation apparatus 11 is an apparatus that calculates a moving route from the current position BP of the autonomous vehicle 100 to a target position TP. Note that the target position TP also includes the orientation of the autonomous vehicle 100. The control apparatus 12 moves the autonomous vehicle 100 along the moving route calculated by the moving route calculation apparatus 11.

Specifically, the moving route calculation apparatus 11 includes a first route calculation unit (first route calculation means) 111, a second route setting unit (second route setting means) 112, a relative position calculation unit (relative position calculation means) 113, and a database 114.

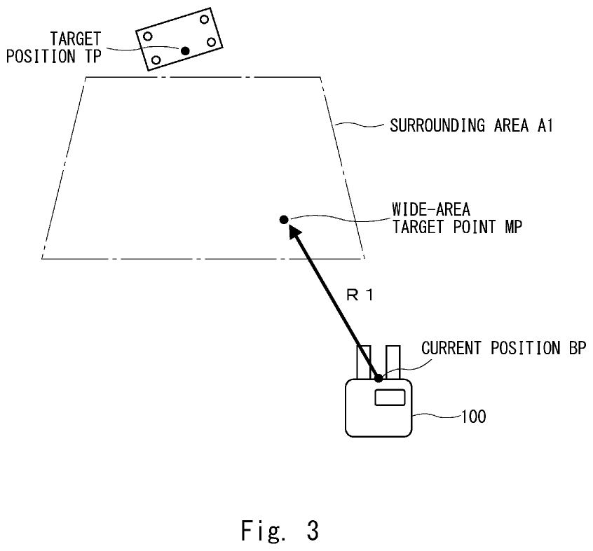

The first route calculation unit 111 estimates the current position (the start position) BP of the autonomous vehicle 100, and calculates a moving route R1 from the estimated current position BP to an arbitrary target point MP located in a surrounding area Al of the target position TP (in other words, one of a plurality of wide-area target points M1 to Mn (n is an integer equal to or larger than two) located in the surrounding area Al of the target position TP). An outline of the calculation of the moving route R1 is also shown in FIG. 3.

Note that the first route calculation unit 111 may calculate a predetermined moving route R1 from the current position BP of the autonomous vehicle 100 to the wide-area target point MP. Alternatively or additionally, the first route calculation unit 111 may estimate the position of itself and create an environmental map simultaneously, for example, by using the SLAM (Simultaneous Localization and Mapping) technology, and thereby may recalculate the moving route R1 as appropriate according to the movement of the autonomous vehicle 100. By doing so, the autonomous vehicle 100 can move to the wide-area target point MP while avoiding obstacles and the like without having a predetermined moving route.

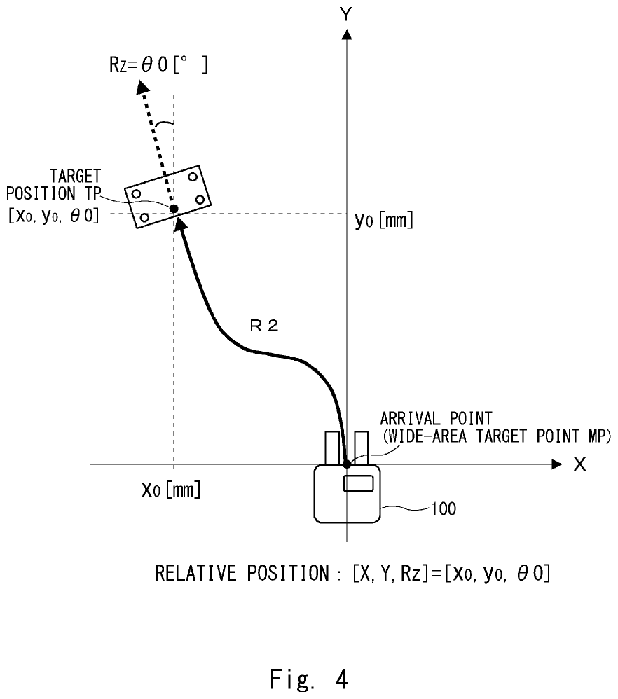

When the autonomous vehicle 100, which has moved along the moving route R1, arrives at the wide-area target point MP, the second route setting unit 112 extracts a moving route R2 from the wide-area target point MP to the target position TP from the database 114, in which a plurality of moving routes are stored in advance, and sets the extracted moving route R2. An outline of the setting of the moving route R2 is also shown in FIG. 4.

In the database 114, a plurality of moving routes D1 to Dn each of which is a moving route from a respective one of the plurality of wide-area target points M1 to Mn located in the surrounding area A1 to the target position TP are stored. Information on these moving routes D1 to Dn stored in the database 114 is obtained in advance by actual measurements or simulations. The simulations include simple calculations such as manual calculations. Note that information on details of control (i.e., control for the velocity, the tire angle, and the like) performed by the control apparatus 12, which are obtained by actual measurements, may be contained in the database.

More specifically, the second route setting unit 112 sets, among the plurality of moving routes D1 to Dn stored in the database 114, a moving route Di (Di is one of D1 to Dn) from a wide-area target point Mi (Mi is one of M1 to Mn) that is substantially coincident with (i.e., coincident with or within a predetermined error range from) the wide-area target point MP, i.e., the arrival point of the autonomous vehicle 100, which has moved along the moving route R1, to the target position TP as the moving route R2 from the wide-area target point MP to the target position TP. In this way, the moving route calculation apparatus 11 can promptly set the moving route R2 without having the autonomous vehicle 100 wait therefor.

Note that if the autonomous vehicle 100 has at least arrived at the surrounding area A1, the second route setting unit 112 can extract the moving route R2 from the arrival point of the autonomous vehicle 100 to the target position TP from the database 114 and set the extracted moving route R2 even when the autonomous vehicle 100 has not yet arrived at the wide-area target point MP. Note that the surrounding area A1 is an area in which the autonomous vehicle 100 can specify the target position TP (in other words, the relative position of the target position TP relative to the autonomous vehicle 100) by a sensing result of the target position TP obtained by the position detection sensor 13 or by an image of the target position TP taken by the camera 14.

That is, the second route setting unit 112 sets, among the plurality of moving routes D1 to Dn stored in the database 114, a moving route Di (Di is one of D1 to Dn) from a wide-area target point Mi that is substantially coincident with (i.e., coincident with or within a predetermined error range from) the arrival point of the autonomous vehicle 100, which has moved along the moving route R1, to the target position TP as the moving route R2 from the arrival point to the target position TP. In this way, the moving route calculation apparatus 11 can promptly set the moving route R2 without having the autonomous vehicle 100 wait therefor.

Further, when there is no wide-area target point that is substantially coincident with the arrival point of the autonomous vehicle 100, which has moved along the moving route R1, in the database 114, the second route setting unit 112 sets, among the plurality of moving routes D1 to Dn stored in the database 114, a moving route Di from a wide-area target point Mi closest to the arrival point of the autonomous vehicle 100 to the target position TP as the moving route R2 from the arrival point to the target position TP. In this way, it is possible to prevent the autonomous vehicle 100 from stopping due to an error which would otherwise be caused because the second route setting unit 112 cannot set the moving route.

More specifically, in the database 114, for example, a plurality of relative positions C1 to Cn each of which is a relative position of the target position TP relative to a respective one of the plurality of wide-area target points M1 to Mn, and a plurality of moving routes D1 to Dn each of which is a moving route from a respective one of the plurality of wide-area target points M1 to Mn to the target position TP are stored while the plurality of relative positions C1 to Cn and the plurality of moving routes D1 to Dn are associated with each other.

The relative position calculation unit 113 calculates a relative position CP of the target position TP relative to the arrival point of the autonomous vehicle 100, which has moved along the moving route R1. The relative position calculation unit 113 calculates the relative position CP of the target position TP from the arrival point of the autonomous vehicle 100, for example, based on an image of the target position TP taken by the camera 14. Alternatively, the relative position calculation unit 113 calculates the relative position CP of the target position TP from the arrival point of the autonomous vehicle 100 based on a sensing result of the target position TP obtained by the position detection sensor 13. Note that only one of the sensor 13 and the camera 14 may be provided in the vehicle control system 1.

Further, the number of the sensor 13 is not limited to one. That is, a plurality of sensors 13 may be provided in the vehicle control system 1. Further, the place where the sensor 13 is installed is not limited to the autonomous vehicle 100. That is, the sensor 13 may be disposed in a place other than the autonomous vehicle 100 as long as it can specify the relative position of the target position TP relative to the autonomous vehicle 100. However, by disposing the sensor 13 in the autonomous vehicle 100, it can recognize the target position TP from a position closer thereto than in the case where the sensor 13 is disposed in a place other than the autonomous vehicle 100, so that the accuracy of the recognition of the target position TP and the accuracy of the route setting are improved.

Similarly, the number of the camera 14 is not limited to one, and a plurality of cameras 14 may be provided in the vehicle control system 1. Further, the place where the camera 14 is installed is not limited to the autonomous vehicle 100. That is, the camera 14 may be disposed in a place other than the autonomous vehicle 100 as long as it can specify the relative position of the target position TP relative to the autonomous vehicle 100. However, by disposing the camera 14 in the autonomous vehicle 100, it can recognize the target position TP from a position closer thereto than in the case where the camera 14 is disposed in a place other than the autonomous vehicle 100, so that the accuracy of the recognition of the target position TP and the accuracy of the route setting are improved.

Further, the second route setting unit 112 sets, among the plurality of moving routes D1 to Dn stored in the database 114, a moving route Di corresponding to a relative position Ci (Ci is one of C1 to Cn) that is substantially coincident with the relative position CP calculated by the relative position calculation unit 113 as the moving route R2 from the arrival point to the target position TP. Further, when there is no relative position that is substantially coincident with the relative position CP calculated by the relative position calculation unit 113 in the database 114, the second route setting unit 112 sets, among the plurality of moving routes D1 to Dn stored in the database 114, a moving route Di corresponding to a relative position Ci closest to the relative position CP as the moving route R2 from the arrival point to the target position TP.

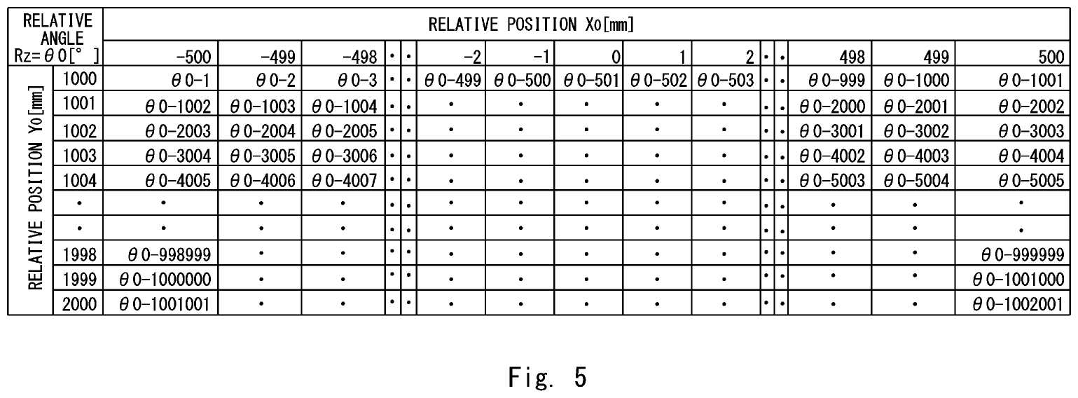

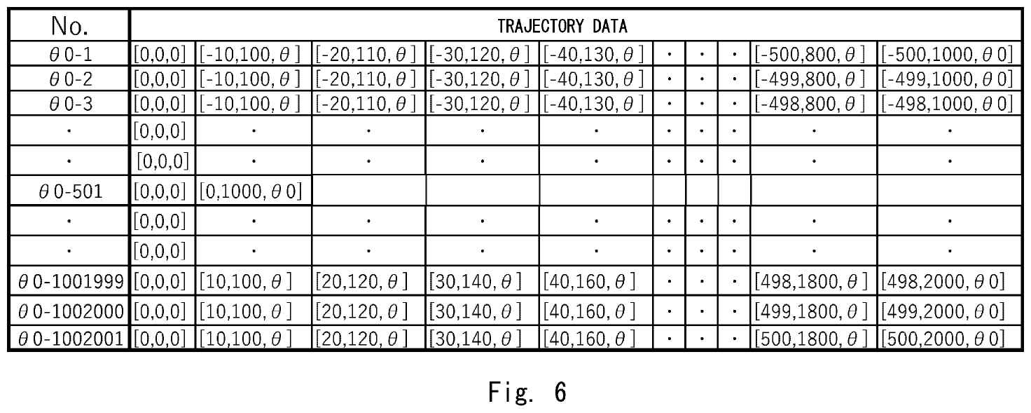

Here, referring to FIG. 4, the relative position of the target position TP with respect to the arrival point of the autonomous vehicle 100, which has moved along the moving route R1, can be expressed, for example, as [X, Y, Rz]=[X0, Y0, θ0], where: X is a coordinate on the horizontal axis; Y is a coordinate on the vertical axis; and Rz is an inclination (the orientation of the autonomous vehicle 100). For example, as shown in FIGS. 5 and 6, a plurality of relative positions each of which is expressed, for example, as [X, Y, Rz]=[X0, Y0, θ0] and a plurality of moving routes each of which corresponds to a respective one of the relative positions are stored in the database 114.

FIG. 5 shows a list of reference numbers of the plurality of relative positions stored in the database 114. FIG. 6 shows an example of a plurality of trajectory data (moving routes) corresponding to the reference numbers of the plurality of relative positions stored in the database 114. Referring to FIGS. 5 and 6, in the case where, for example, X0=−500 [mm], Y0=1,000 [mm], and Rz=θ0, trajectory data (a moving route) corresponding to a reference number “θ0-1” is extracted. Further, in the case where, for example, X0=−500 [mm], Y0=1,005 [mm], and Rz=θ0, trajectory data (a moving route) corresponding to a reference number “θ0-5006” is extracted.

(Operation of Movable Body Control System 1)

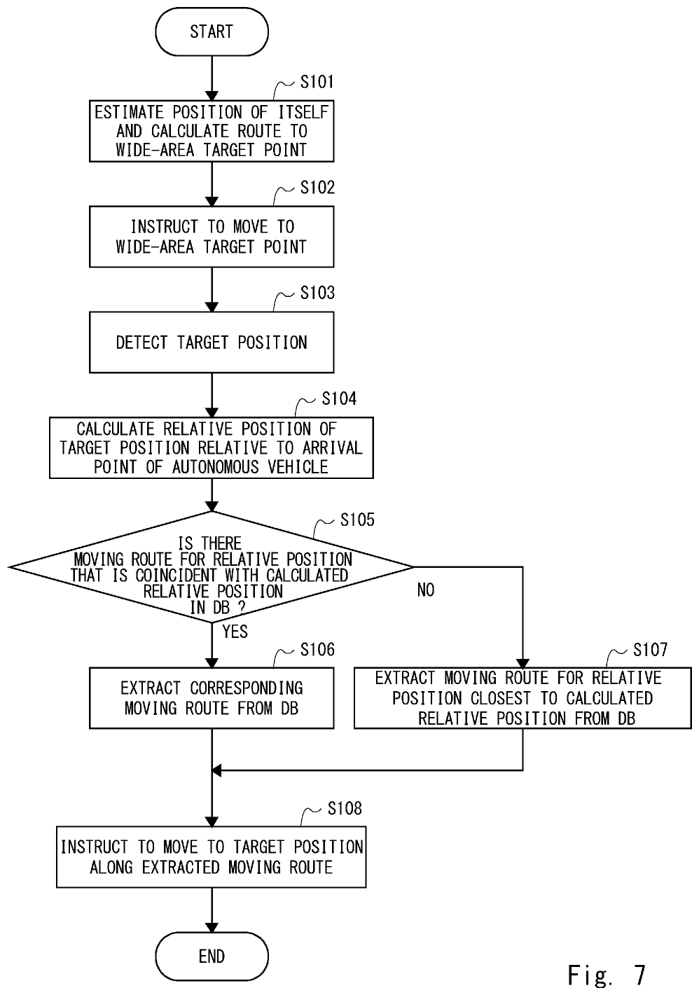

Next, operations performed by the vehicle control system 1 will be described hereinafter with reference to FIG. 7.

FIG. 7 shows a flowchart showing the operations performed by the vehicle control system 1.

Firstly, the first route calculation unit 111 estimates the current position BP of the autonomous vehicle 100, and calculates a moving route R1 from the estimated current position BP to an arbitrary target point MP located in a surrounding area A1 of the target position TP (in other words, one of a plurality of wide-area target points located in the surrounding area Al of the target position TP) (Step S101). Then, the control apparatus 12 instructs the autonomous vehicle 100 to move to the wide-area target point MP along the moving route R1 calculated by the first route calculation unit 111 (Step S102). As a result, the autonomous vehicle 100 moves toward the wide-area target point MP along the moving route R1.

Note that, in this example, the first route calculation unit 111 estimates the position of itself and creates an environmental map simultaneously, for example, by using the SLAM technology, and thereby recalculates the moving route R1 as appropriate according to the movement of the autonomous vehicle 100. By doing so, the autonomous vehicle 100 can move to the wide-area target point MP while avoiding obstacles and the like without having a predetermined moving route.

When the autonomous vehicle 100, which has moved along the moving route R1, arrives at the wide-area target point MP or a vicinity thereof (i.e., at least arrives within the surrounding area A1), the target position TP is detected by the sensor 13, the camera 14, or the like (Step S103). Note that, in this example, it is assumed that the autonomous vehicle 100, which has moved along the moving route R1, has arrived at the wide-area target point MP.

Note that in the database 114, for example, a plurality of relative positions C1 to Cn each of which is a relative position of the target position TP relative to a respective one of the plurality of wide-area target points M1 to Mn located in the surrounding area A1, and a plurality of moving routes D1 to Dn each of which is a moving route from a respective one of the plurality of wide-area target points M1 to Mn to the target position TP are stored while the plurality of relative positions C1 to Cn and the plurality of moving routes D1 to Dn are associated with each other.

The relative position calculation unit 113 calculates a relative position CP of the target position TP relative to the arrival point of the autonomous vehicle 100, which has moved along the moving route R1 (Step S104). The relative position calculation unit 113 calculates the relative position CP of the target position TP from the arrival point of the autonomous vehicle 100, for example, based on an image of the target position TP taken by the camera 14. Alternatively, the relative position calculation unit 113 calculates the relative position CP of the target position TP from the arrival point of the autonomous vehicle 100, for example, based on a sensing result of the target position TP obtained by the position detection sensor 13.

Then, when there is a relative position substantially coincident with the relative position CP calculated by the relative position calculation unit 113 in the database 114 (Yes in step S105), the second route setting unit 112 sets, among the plurality of moving routes D1 to Dn stored in the database 114, a moving route Di corresponding to a relative position Ci that is substantially coincident with the relative position CP calculated by the relative position calculation unit 113 as the moving route R2 from the arrival point to the target position TP (Step S106).

Note that when there is no relative position that is substantially coincident with the relative position CP calculated by the relative position calculation unit 113 in the database 114 (No in step S105), the second route setting unit 112 sets, among the plurality of moving routes D1 to Dn stored in the database 114, a moving route Di corresponding to a relative position Ci closest to the relative position CP as the moving route R2 from the arrival point to the target position TP (Step S107).

In short, the second route setting unit 112 extracts a moving route R2 from the arrival point of the autonomous vehicle 100, which has moved along the moving route R1, (e.g., from the wide-area target point MP) to the target position TP from the database 114 in which a plurality of moving routes are stored in advance, and sets the extracted moving route R2. In this way, the moving route calculation apparatus 11 can promptly set the moving route R2 without having the autonomous vehicle 100 wait therefor.

After that, the control apparatus 12 instructs the autonomous vehicle 100 to move to the target position TP along the moving route R2 set by the second route setting unit 112 (Step S108). As a result, the autonomous vehicle 100 moves toward the target position TP along the moving route R2.

As described above, according to this embodiment, when the autonomous vehicle 100 arrives at an area where it can recognize the target position TP, the moving route calculation apparatus 11 or the vehicle control system 1 including the moving route calculation apparatus 11 extracts, promptly and with a small amount of processing load, a moving route from this arrival point to the target position TP from the database, in which a plurality of moving routes are stored in advance, and sets the extracted moving route. In this way, unlike the related art, the moving route calculation apparatus 11 or the vehicle control system 1 including the moving route calculation apparatus 11 does not need to stop the movement of the autonomous vehicle 100 for the setting of the moving route, so that it can speedily move the autonomous vehicle 100 to the target position TP.

Note that the present disclosure is not limited to the above-described embodiments, and they can be modified as appropriate without departing from the scope and spirit of the disclosure. For example, although an example case where the first route calculation unit 111, the second route setting unit 112, the relative position calculation unit 113, and the database 114 are disposed in one moving route calculation apparatus 11 (one computer) is described in this embodiment, the configuration of the present disclosure is not limited to this example. That is, they may be disposed in a distributed manner over a plurality of apparatuses (a plurality of computers) constituting the moving route calculation apparatus 11 according to the data capacity and the processing load.

Further, in the present disclosure, it is possible to implement some or all of the processes performed in the moving route calculation apparatus 11 or the vehicle control system 1 including the moving route calculation apparatus 11 by having a CPU (Central Processing Unit) execute a computer program(s).

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A moving route calculation apparatus configured to calculate a moving route for an autonomous vehicle, comprising:
a first route calculation unit configured to calculate a first route, the first route being a moving route from a start position to one of a plurality of wide-area target points located in a surrounding area of a target position;
a database in which a plurality of moving routes each of which is a moving route from a respective one of the plurality of wide-area target points to the target position are stored; and
a second route setting unit configured to set, among the plurality of moving routes stored in the database, a moving route from a wide-area target point corresponding to the arrival point of the autonomous vehicle, which has moved along the first route, to the target position as a second route, the second route being a moving route from the arrival point of the autonomous vehicle to the target position.

2. The moving route calculation apparatus according to claim 1, further comprising a relative position calculation unit configured to calculate a relative position of the target position relative to the arrival point of the autonomous vehicle, which has moved along the first route, wherein
in the database, a plurality of relative positions of the target position each of which is a relative position relative to a respective one of the plurality of wide-area target points and a plurality of moving routes each of which is a moving route from a respective one of the plurality of wide-area target points to the target position are stored while the plurality of relative positions of the target position and the plurality of moving routes are associated with each other, and
the second route setting unit sets, among the plurality of moving routes stored in the database, a moving route corresponding to the relative position calculated by the relative position calculation unit as the second route, which is the moving route from the arrival point of the autonomous vehicle to the target position.

3. The moving route calculation apparatus according to claim 2, wherein the surrounding area of the target position is an area in which the target position can be specified by the relative position calculation unit.

4. The moving route calculation apparatus according to claim 2, wherein the relative position calculation unit calculates the relative position of the target position from the arrival point of the autonomous vehicle based on an image of the target position taken by a camera.

5. The moving route calculation apparatus according to claim 2, wherein the relative position calculation unit calculates the relative position of the target position from the arrival point of the autonomous vehicle based on a sensing result of the target position obtained by a position detection sensor.

6. The moving route calculation apparatus according to claim 1, wherein the second route setting unit sets, among the plurality of moving routes stored in the database, a moving route from a wide-area target point that is coincident with or within a predetermined error range from the arrival point of the autonomous vehicle to the target position as the second route, which is the moving route from the arrival point of the autonomous vehicle to the target position.

7. The moving route calculation apparatus according to claim 1, wherein the second route setting unit sets, among the plurality of moving routes stored in the database, a moving route from a wide-area target point closest to the arrival point of the autonomous vehicle to the target position as the second route, which is the moving route from the arrival point of the autonomous vehicle to the target position.

8. A vehicle control system comprising:
a moving route calculation apparatus according to claim 1; and
a control apparatus configured to move an autonomous vehicle along a moving route calculated by the moving route calculation apparatus.

9. A vehicle control system comprising:
moving route calculation apparatus according to claim 4;
the camera; and
a control apparatus configured to move an autonomous vehicle along a moving route calculated by the moving route calculation apparatus.

10. A vehicle control system comprising:
a moving route calculation apparatus according to claim 5;
the position detection sensor; and
a control apparatus configured to move an autonomous vehicle along a moving route calculated by the moving route calculation apparatus.

11. A method for calculating a moving route, comprising:
calculating a first route, the first route being a moving route from a start position to one of a plurality of wide-area target points located in a surrounding area of a target position; and
setting, among a plurality of moving routes each of which is a moving route from a respective one of the plurality of wide-area target points to the target position, stored in a database, a moving route from a wide-area target point corresponding to an arrival point of the autonomous vehicle, which has moved along the first route, to the target position as a second route, the second route being a moving route from the arrival point of the autonomous vehicle to the target position.

12. A non-transitory computer readable medium storing a moving route calculation program for causing a computer to perform:
a process of calculating a first route, the first route being a moving route from a start position to one of a plurality of wide-area target points located in a surrounding area of a target position; and
a process of setting, among a plurality of moving routes each of which is a moving route from a respective one of the plurality of wide-area target points to the target position, stored in a database, a moving route from a wide-area target point corresponding to an arrival point of the autonomous vehicle, which has moved along the first route, to the target position as a second route, the second route being a moving route from the arrival point of the autonomous vehicle to the target position.
